(19) United States
(12) Patent Application Publication
(10) Pub. No.: US 2003/0172893 A1
(43) Pub. Date: Sep. 18, 2003

(54) Starting method and device for internal combustion engines

(76) Inventor: Manfred Ackermann, Oppenweiler (DE)

Correspondence Address: Walter Ottesen, Patent Attorney, P O Box 4026, Gaithersburg, MD, 20885-4026, US

(21) Appl. No.: 10/276,593

(22) PCT Filed: Mar. 27, 2001
(86) PCT No.: PCT/DE01/01168

(30) Foreign Application Priority Data
May 19, 2000 (DE) 100 24 438.6

(51) Int. Cl. F02N 17/00

(52) U.S. Cl. 123/179.5; 123/182.1

(57) ABSTRACT

The invention relates to a start method and a start arrangement for an internal combustion engine (10) of motor vehicles having a crankshaft (11) connected to an electric machine (14) for cranking the engine. Crankshaft position and rotation are detected by a start control apparatus (19) and evaluated for controlling each start operation of the engine. The crankshaft (11) is first brought by the electric machine (14) into a start position during a positioning phase for each start operation.

For achieving the shortest possible start times and smallest possible crank torque of the electric machine, it is provided that, in a start phase, which follows the positioning phase, a first combustion with reduced compression and reduced charge level is triggered in the at least first cylinder going into compression which combustion supports the crank torque of the electric machine (14).

### STATE OF THE ART

The invention relates to a starting method for an internal combustion engine of a motor vehicle in accordance with the preamble of claim 1 as well as a starting arrangement for carrying out the method.

Motor vehicles, which are optimized with respect to fuel consumption, require, inter alia, a switchoff of the engine at traffic lights in the so-called start-stop operation as well as a switchoff and clutch disengagement of the engine in so-called overrun phases. This leads to a markedly increased number of starting cycles of the engine. On the other hand, markedly increased demands are imposed on the electric on-board network power by increasing vehicle comfort. To realize a high generator power in the lower rpm range of the engine as well as a high starting cycle number of the engine, an electric machine was developed in the meantime, which is useable as a starter as well as a generator and is characterized as a starter generator. In the generator operation, the electric machine is driven by the internal combustion engine via a switchover gear already in the lower rpm range at rpms which are sufficiently high for generating current; whereas, in the start operation of the engine, the electric machine drives the internal combustion engine in motor operation at low rpm and high torque. The start of the engine requires a drive which is dimensioned to the cold-start limit temperature of approximately −25° C. and has to be designed for the then occurring sum of drag torque, gas spring torque and acceleration torque of the engine. The inertial torque of the starter generator, which is effective in the starting operation is much less compared to the inertial torque of a conventional starter. For this reason, the cranking torque of the starter generator must be correspondingly significantly increased so that the rpm of the crankshaft does not drop too much because of the compression in the cylinders of the engine.

From German patent publication 198 58 992, it is already known to detect the drag torque of an engine with a control apparatus in advance of each starting operation of the engine by rotating the crankshaft by means of the starter generator and to carry out a cold start or a warm start with a correspondingly different starting sequence in dependence upon the drag torque. While, for a warm engine, a so-called direct start is carried out as in a conventional starter with full cranking torque of the electric machine, for a cold engine, a positioning of the crankshaft into a start position first takes place by means of the starter generator and thereafter a decoupled flywheel is brought to a pregiven rpm by the starter generator and then the rotating flywheel is superposed onto the crankshaft via a switch clutch for a so-called pulse start.

Here, it is disadvantageous that the weight of the vehicle and therefore the fuel consumption increases with the flywheel and that a relatively long starting time and a correspondingly large amount of energy is necessary for bringing the flywheel up to speed. In a warm start, a dynamic starting sequence is furthermore made difficult in that the rpm of the crankshaft collapses so much with the first full compression of a cylinder at its top dead center that, to prevent a back swing in the first cylinder going into compression, no ignition can take place.

With the present invention, it is intended to reduce the cranking torque of the electric machine and the starting time of the engine.

### ADVANTAGES OF THE INVENTION

The starting method according to the invention for the internal combustion engine of a motor vehicle having the characterizing features of claim 1 as well as the starting unit provided for carrying out the method with the characterizing features of claim 19 afford the advantage that a clear reduction of the cranking torque of the electric machine for a warm start and a cold start is achieved via a compression reduction and a degree of charge reduction, which is carried out by the start control apparatus, in the first cylinder of the engine, which goes in compression in the starting phase as well as a clear reduction of the starting time is achieved in a cold start by avoiding a so-called pulse start. In this way, an effective support of the electric machine, which cranks the engine, is achieved in the start-stop operation, which leads to a marked reduction of the warm start time. A further advantage is that for less than half a revolution of the crankshaft, a first combustion in the cylinder, which goes first in compression, can be triggered, which supports the complete cranking torque of the electric machine so that, after the shortest time, a torque, which leads to a self-running, is generated at the crankshaft of the engine. With a suitable programming of the start control apparatus, a decision can be made in a manner known per se, for example, via a temperature measurement at the engine, as to whether a cold start or a warm start is to be carried out. In lieu of a temperature measurement, the drag torque of the engine can be determined in a manner known per se by rotating the crankshaft by means of the electric machine and can be used to trigger a cold start or a warm start.

Advantageous further embodiments and configurations are evident from the further features which are mentioned in the dependent claims. In multi-cylinder internal combustion engines, the cylinders go into compression in relatively short intervals or rotation intervals because of the rotation of the crankshaft. For this reason, the cranking torque of the electric machine is supported by several combustions at reduced compression and reduced degree of air charge for a cranking of the engine as uniform as possible during the starting phase. Here, in an advantageous manner, for the cylinders which go sequentially into compression, the compression and the charge level increases in steps to their full value of 100%. The stepwise increase can be fixedly pregiven by the starting control apparatus. In an advantageous manner, however, it is suggested that the compression and charge level be controlled respectively in dependence upon the previous rpm performance of the crankshaft charged by the crank torque of the electric machine with a program of the starter control apparatus suitable therefor.

For an optimal support of the cranking torque of the electric machine, it is further of considerable significance that, in the starting phase, the combustion is triggered by a reduced fuel quantity adapted to the reduced level of charge of the cylinder.

For an improved starting dynamic, it is furthermore of considerable significance that the crankshaft be brought into a first start position for a warm start or into a subsequent second start position for a cold start of the engine in dependence upon a state of the engine detected by the starting control apparatus. In an advantageous manner, for a warm start, the start position is pregiven by the starting control apparatus at approximately 60° ahead of top dead center of the cylinder going into compression. For the cold start, in an advantageous manner, the start position is pregiven at approximately 40° in advance of top dead center of the cylinder going into compression.

The degree of compression and the degree of charge of the cylinder going into compression is reduced in an advantageous manner via a free valve control because of a delayed closure of the inlet valves compared to the normal operation of the engine. For this purpose, an electromagnetic valve control is especially suitable. However, mechanical valve stroke controls can also be considered as alternatives. In internal combustion engines having a high number of cylinders, the load torque or gas spring torque of the sequentially occurring compressions add in a disturbing manner. For this reason, it is suggested in an advantageous manner that, for engines having an even number of cylinders, the degree of charge and the compression are controlled to zero on each second cylinder going into compression when there are more than six cylinders. The charge degree steps of the remaining cylinders can then, as already mentioned, be matched to each other in stages. The transition to the full cylinder number can take place without difficulty via the starting control apparatus when the rpm exceeds a pregiven limit value to self-running.

For each starting operation, the crankshaft must first be brought into its start position by the electric machine. This is done with reference to the first cylinder going into compression. For a warm start in the so-called start-stop operation, this is realized in an advantageous manner in that, with the beginning of the stop phase, the crankshaft is brought into its start position by the electric machine when there is a pendular movement and is held for the next starting phase to be triggered by the driver of the vehicle. In a cold start, the crankshaft is, in contrast, rotated into the start position assigned to the cold start solely by the electric machine. Alternatively to a free valve control, a reduction of the compression and of the degree of charge is to be undertaken here via a so-called leakage in the cylinder. For this purpose, it is suggested in an advantageous manner to reduce compression and degree of charge via leakages of the cylinder by slowly rotating the crankshaft into the start position at the cylinder going first into compression. In the event that this takes too much time, the crankshaft is first brought into its start position by the electric machine during the positioning phase in order to reduce the compression and degree of charge via leakages of the cylinder via a pregiven dwell duration in the start position up to the beginning of the start phase. For a precise control of the start position, the torque of the electric machine can be reduced. It is purposeful to hold the crankshaft in its start position until the gas spring pressure of the cylinder going into compression is dropped to a residual value.

Depending upon the degree of compression and the degree of charge of the first cylinder of the engine going into compression, correspondingly reduced fuel quantities are injected into respective cylinders via an injection control known per se. In internal combustion engines having direct injection, it is especially advantageous that the pregiven fuel quantity is injected at reduced compression during the first compression phase. In internal combustion engines having intake manifold injection, it is, in contrast, advantageous that the pregiven fuel quantity is injected through the inlet valve still open for the first compression phase with reduced compression, preferably, in the induction phase in advance of bottom dead center of the piston of the cylinder going into compression. In both cases, a first combustion, which supports the cranking torque of the electric machine, can be triggered at a relatively small rotational angle of the crankshaft of approximately 100°.

The start method according to the invention is carried out with a start arrangement wherein the start control apparatus is connected to a rotation sensor and a position sensor of the crankshaft and, at the output end, is connected to the electric machine, the valve control and the fuel injection control of the engine.

### DRAWING

Further details of the invention are explained in greater detail in the following described embodiments with reference to the corresponding drawings.

FIG. 1 shows the drive equipment of a motor vehicle in schematic representation with a start arrangement for carrying out the start method of the invention; and,

FIG. 2 shows a table for a stepped reduction of the degree of charge via a stepped closure of the respective inlet valve in advance of top dead center or via stepped opening and closing in advance of bottom dead center.

### DESCRIPTION OF THE EMBODIMENTS

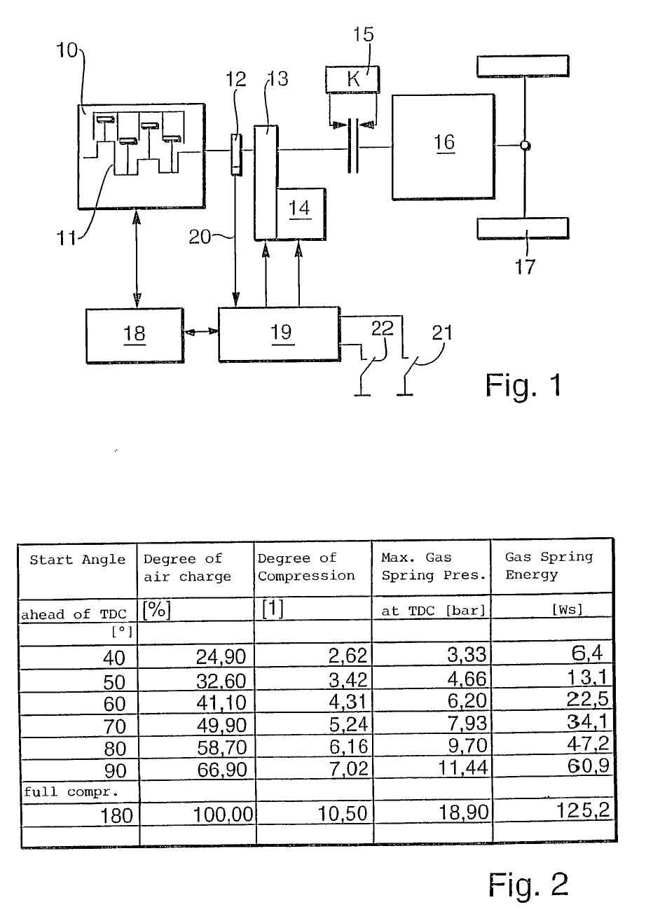

The internal combustion engine is identified by 10 in the schematic representation of the drive equipment for a motor vehicle of FIG. 1. The engine shown is a four-cylinder spark ignition engine whose crankshaft 11 operates together with a rotation and position sensor 12. Furthermore, the crankshaft 11 is connected via a shift transmission 13 to an electric machine 14, which coacts as a starter generator with the engine 10. The crankshaft 11 is further connected via a clutch 15 to a vehicle transmission 16 having an output via which the drive wheels 17 of the motor vehicle (not shown) are driven by the engine 10. Furthermore, an electronic engine control apparatus 18 is present with which the injection valves (not shown), inlet and outlet valves as well as the ignition to the individual cylinders of the engine 10 are controlled and wherein furthermore, the position of the crankshaft is detected. An electronic start control apparatus 19 is electrically connected to the engine control apparatus 18. The start control apparatus 19 is connected at its input end via a signal line 20 to the rotation and position sensor 12 and, at is output end, controls the shift transmission 13 as well as the electric machine 14. The start control apparatus 19 further communicates with the engine control apparatus 18. The shift transmission 13 can be driven by the start control apparatus 19 in such a manner that, for start operations, the electric machine 14, which is driven by the engine, can be superposed onto the crankshaft 11 with high torque and low rpm. In the generator operation of the electric machine 14, however, the shift transmission 13 is so switched that even in idle of the engine 10, the electric machine 14 is driven at a sufficiently high rpm in order to supply, to an adequate extent, the on-board network (not shown) of the motor vehicle. The particular precise position of the crankshaft 11 and therefore the position of the individual cylinders of the engine 10 is detected in the start control apparatus 19 with the rotation and position sensor 12. A switch 21 can, for example, be integrated in the ignition switch of the motor vehicle. Via the switch 21, a cold start can be triggered by the vehicle operator. A warm start can be triggered in start-stop operation of the motor vehicle via an accelerator pedal switch 22.

In a first embodiment, the start method according to the invention will be explained in greater detail for a cold start and a warm start.

The first start operation is always a cold start. The cold start is triggered with the closing of the start switch 21. In the start control apparatus 19, the position of the crankshaft 11 and therefore the positions of the pistons in the cylinders are detected via the sensor 12. In the positioning phase which now follows, the electric machine 14 and the shift transmission 13 are switched to engine operation by the start control apparatus 19 and the electric machine 14 begins to rotate the crankshaft 11 with a torque, which is pregiven by the start control apparatus 19, into its start position pregiven for the cold start. At the same time, at the first cylinder going into compression with the crankshaft rotation, the inlet valve is opened or held open by the start control apparatus 19 via the engine control apparatus 18 until the start position is reached at 40° ahead of top dead center (TDC) of the cylinder going into compression. Then, the inlet valve is closed and, for direct injection, an injection quantity, which is reduced compared to idle, is injected into the cylinder. With the beginning start phase, the crankshaft 11 is rotated with full crank torque by the electric machine and, after a quarter revolution, a first combustion is triggered in the cylinder having reduced compression and this combustion supports the electric machine 14 and accelerates the crankshaft 11.

Now the second cylinder also goes into compression and the start control apparatus 19 closes the inlet valve of the second cylinder via the engine control apparatus 18 at 60° ahead of top dead center to achieve a reduced degree of compression and charge. Here too, a correspondingly reduced fuel quantity is injected and, after approximately ⅓ crankshaft rotation, a second combustion is triggered in the second cylinder and this combustion supports the runup of the engine 10. Thereafter, the third cylinder goes into compression and here too, the inlet valve of the third cylinder is closed only at 80° ahead of top dead center via the start control apparatus 19. In this way, also the third compression is reduced and, after approximately ⅓ crankshaft rotation, a third combustion, which supports the runup of the engine, takes place. Only when the fourth cylinder goes into compression, is the compression reduction switched off so that the further runup of the engine by the electric machine 14 is supported by the engine 10 with its idle parameters with respect to compression, degree of charge, injection quantity and ignition time point.

From the table of FIG. 2, it can be seen that, with a reduction of the closing position of the inlet valves in this manner, a reduced compression and a reduced degree of air charge is achieved with which the maximum so-called gas spring pressure in the cylinders is considerably reduced. In this way, the start phase of the engine is significantly reduced with the pregiven crank torque of the electric machine. With this grading with increasing degree of charge of the cylinders, only a minimum cold start crank torque has to be developed by the electric machine because the compression work, which increases with increasing degree of charge, is done by the previous supporting combustion without there being a collapse of the rpm. The attainment of the idle rpm is detected by the sensor 12 and the start operation is ended by the start control apparatus 19 in that, for example, the electric machine 14 and the shift transmission 13 are switched over to generator operation.

In the start-stop operation, the motor vehicle is, for example, stopped for a short time at traffic lights and the engine is switched off. With a pendular movement of the crankshaft, the cylinder, which is first to go into compression in the subsequent warm start, is detected by the start control apparatus 19 and the crankshaft is brought into the start position, which is pregiven for a warm start, with the aid of the electric machine 14. The crankshaft is held there with the aid of the electric machine 14 until the start phase, which is triggered by the vehicle operator by closing the accelerator pedal switch 22. The inlet valve of the particular cylinder is likewise held open up to the start position. For the warm start, a start position of 60° ahead of top dead center (TDC) of the first cylinder to go into compression is provided.

With the start phase for the warm start, the inlet valve is closed, the reduced fuel quantity is injected into the cylinder and the crankshaft 11 is accelerated with the full crank torque of the electric machine 14. After approximately a 90° crankshaft rotation, a first combustion is triggered, which supports the crank torque of the electric machine 14. At the same time, the second cylinder goes into compression. Here too, a reduced degree of compression and reduced charge is achieved in that the inlet valve is closed only 90° in advance of TDC. For a warm start, the drag torque of the engine 10 is considerably less than in a cold start. For this reason, the reduction of the degree of charge can be switched off by the start control apparatus 19 already with the third cylinder going into compression so that already with the third combustion, a further runup of the engine is ensured. The start control apparatus 19 ends the start operation with achieving the idle rpm and switches the electric machine then over into generator operation.

If the vehicle is equipped with a so-called overrun cutoff, then the above-described warm start of the engine is triggered at the end of the overrun phase by the actuation of the accelerator pedal switch 22.

In a further embodiment of the start method of the invention for internal combustion engines, the inlet valve at the cylinder of the engine, which first goes into compression, is closed in a cold start by the start control apparatus 19 at bottom dead center so that the start position must be driven to already when overcoming the compression start in the first cylinder. To nonetheless achieve a reduced degree of compression and charge for the first cylinder, the crankshaft 11 of the internal combustion engine 10 is rotated by the electric machine 14 with a greatly reduced crank torque into the start position pregiven for a cold start. The compression which builds up is reduced again substantially by leakages in the cylinder. In the subsequent start phase, the crankshaft 11 is then rotated with the full crank torque of the electric machine 14. Here too, a first combustion with reduced compression and reduced charge level is triggered after approximately ⅓ crankshaft rotation in the cylinder of the engine going into compression with the combustion supporting the crank torque of the electric machine 14. In internal combustion engines having a low number of cylinders, this leads to a simplified embodiment because the engines do not need an additional control of the inlet valves insofar as the start operation leads to a stable runup of the engine already with a reduced compression of the first cylinder.

For a warm start too, the reduced compression in such engines is realized in the first cylinder without additional driving of the inlet valves because, in the start-stop operation as well as in overrun operation with the previous switchoff of the engine, respectively, the start position is driven to by the electric machine 14 when there is a pendular movement of the crankshaft and is held at this start position. Because of the leakages in the cylinder, the compression, which is already present in the cylinder, is substantially reduced during the dwell duration up to the renewed start so that, with the closing of the accelerator pedal switch 22, the start phase can be run through with a reduced first compression and, after approximately ⅓ crankshaft rotation, a first combustion, which supports the crank torque of the electric machine 14, is triggered.

Alternatively to the above-described positioning phase for the cold start, it is likewise well possible that the crankshaft 11 is brought into the start position during the positioning phase with the full crank force of the electric machine 14 and that the partial compression, which is already available because of the closing of the inlet valve, is reduced because of leakages in the cylinder via a pregiven dwell duration pregiven by the start control apparatus 19 so that, in the next start phase, compression and charge level are reduced to the wanted extent in the first cylinder.

The drag torque of the engine, which is to be overcome by the electric machine, is significantly higher in a cold start than for a warm start. For this reason, it is important that the compression (especially in the first cylinder), which is to be additionally overcome by the electric machine, is more reduced for the cold start than for the warm start. The warm or cold condition of the engine can therefore be detected by the start control apparatus from the rotation performance of the engine in the positioning phase. Alternatively thereto, this can be detected by the start control apparatus via a temperature measurement of the engine. In the positioning phase, the crankshaft is brought into a first start position for a warm start or into a subsequent second start position for a cold start of the engine in dependence upon the state of the engine. The first start position is pregiven at approximately 60° ahead of top dead center and the second start position is pregiven at approximately 40° ahead to top dead center of the cylinder going into compression.

As mentioned above, for an internal combustion engine having direct injection, the pregiven fuel quantity is injected during the first compression phase with reduced compression. For internal combustion engines having intake manifold injection, the fuel quantity is injected via the inlet valve which is still open. The injection then starts preferably with the lower dead center point of the cylinder going into compression.

The reduced compression in the start phase effects, on the one hand, a reduction of the needed crank torque of the electric machine from the start position of the crankshaft. On the other hand, the engine achieves still a sufficient degree of air charge of 25 to 40% with which a first combustion in the cylinder is achieved, which greatly supports the crank torque with the then correspondingly adapted fuel injection quantity.

Start attempts with internal combustion engines equipped in the above manner show for different pendular positions of the engine that, because of the relatively low start inertial torques, very great differences in the start performance are present, especially in the start dynamic and in the minimally required crank torque. For low and average cylinder numbers of three to six cylinders as well as for diesel engines, these start position dependencies are especially pronounced. In start arrangements having a starter generator, one expects a reliable and dynamic start function. For the cold start limit temperature, a start time up to several seconds is still acceptable; whereas, for a warm start, the reduction of the start time is primary. The reduction of the needed crank torque is important because the continuous current, which is needed in generator operation, on the one hand, and the start current, on the other hand, are in such relationship to each other that the generator current remains determinative for design. In this case, the complexity for the electric machine and the inverter, which is needed for motor operation, can be minimized.

With the start method of the invention, a coordination of the start sequence and the start application is possible with a stepped compression and charge level control of the first cylinders, which contribute to combustion, with a minimized crank torque, which leads to a reliable cold start and a warm start with significantly reduced start time. In addition to the known angular sensors, rpm and rotational angle signals of the electric machine can also be used.

A relatively large injection time can be needed for a compression reduction via leakages at low temperatures of the engine and for correspondingly large injection quantities. For this reason, the crankshaft must be held in its injection position (if needed up to the end of the injection time). Compared to engines having conventional starters, the crankshaft here for a cold start is accelerated with relatively low inertial torque from its start position. Here, to overcome the first reduced compression, only approximately 20% energy is required compared to full compression so that the rpm already reaches a high value of, for example, 150 to 200 rpm after a start acceleration. The rpm will stagnate in the upper dead center region of the first cylinder at approximately this level but will not totally collapse as when overcoming a full compression. After top dead center, a partial energy of the decompression can be used and up to approximately 40% of the full torque of a compression in this cylinder so that the subsequent full compression can be overcome without an rpm breakdown and thereafter the self-running is achieved with high dynamic.

For a cold start, the positioning of the crankshaft of the engine can also be carried out with a comparatively low crank torque even at cold start limit temperatures. This low crank torque can, for example, be 50% less than the full crank torque. This is possible when one considers a maximum positioning time of approximately 2 seconds as well as the ignition interval as a maximum rotational angle to be run through up to the start position (that is, 180° for a four-cylinder engine) as still permissible.

It is known that at rpms significantly below 100 with increasing compression in the cylinder and with increasing crank torque, the largest part of the supplied energy is consumed by the increase of the leakage and wall thermal losses in the cylinder and only a lesser part leads to an increase of the crankshaft rpm. These losses are reduced in that, in the positioning phase in the second embodiment, the crankshaft is first brought into its start position with a lesser crank torque and only from this position the switchover to the full crank torque is undertaken. The suitable start position is similarly so selected as in the warmstart positioning so that, in the first acceleration phase, only a reduced compression must be run through. The air charge level and therefore also the torques, which are achievable after top dead center by the compression, have, however, already a high value for supporting the start operation.

In FIG. 2, the conditions in the cylinders for reduced compression are made clear in a table.

The table presents the following: the degree of air charge in percent for the maximum possible value; the degree of compression compared to normal pressure; the gas spring pressure which is measured in bar at top dead center; and, the gas spring energy, which results therefrom, and particularly for a start angle increasing in a stepwise manner. Here, the start angle is that angle which the crankshaft assumes in the start position relative to the top dead center of the first cylinder going into compression. The table shows that for a reduced compression, the gas spring energy, which is to be developed by the electric machine in the start operation, is significantly overproportionally reduced relative to the charge level.

1. Start method for an internal combustion engine (10) of a motor vehicle having a vehicle transmission (16) between the crankshaft (11) of the engine and the drive wheels (17) of the vehicle, the motor vehicle including a clutch (15) between the vehicle transmission and the crankshaft and including an electric machine (14), which is connected to the crankshaft for cranking the engine; the motor vehicle further including a start control apparatus (19) for detecting the crankshaft position and crankshaft rotation and for controlling each start operation of the engine; for each start operation, the crankshaft is brought by the electric machine into a start position ahead of TDC in a positioning phase; characterized in that, in a subsequent start phase, a first combustion with reduced compression and reduced charge level is triggered in the at least first cylinder of the engine (10) going into compression, this compression supporting the effective crank torque of the electric machine (14) on the crankshaft (11) in the start phase.

2. Start method of claim 1, characterized in that, during the start phase, the crank torque of the electric machine (14) is supported by several combustions with reduced compression and reduced charge level in the cylinders of the engine (10).

3. Start method of claim 2, characterized in that the compression and the charge level are increased in steps to the full value (100%).

4. Start method of claim 3, characterized in that the compression and fill level are respectively controlled in dependence upon the previous rpm course of the crankshaft (11).

5. Start method of one of the above claims, characterized in that, in the start phase, the combustion is triggered with a reduced fuel quantity adapted to the reduced charge level of the cylinder.

6. Start method of one of the above claims, characterized in that, depending upon the state of the engine (10) detected by the start control apparatus (19) in the positioning phase, the crankshaft (11) is brought into a first start position for a warm start or into a subsequent second start position for a cold start of the engine.

7. Start method of claim 6, characterized in that the first start position is pregiven at approximately 60° ahead of top dead center of the cylinder of the engine (10) going into compression.

8. Start method of claim 6 or 7, characterized in that the second start position is pregiven at approximately 40° ahead of top dead center of the cylinder of the engine (10) going into compression.

9. Start method of one of the above claims, characterized in that compression and fill level of the cylinder going into compression are reduced via a free valve control of the inlet valves.

10. Start method of one of the above claims, characterized in that, for internal combustion engines having an even number of cylinders greater than 6, there is a control of compression and charge level to 0% for each second cylinder going into compression.

11. Start method of claim 6, characterized in that, in the start-stop operation of the vehicle, with the beginning of a stop phase, the crankshaft (11), while it is in a pendular movement, is brought into a start position by the electric machine (14) and is held in the start position up to the next start phase triggered by the driver of the vehicle.

12. Start system of one of the above claims, characterized in that compression and fill level of the first cylinder going into compression is reduced by a slow rotation of the crankshaft (11) into the start position via leakages of the cylinders.

13. Start method of one of the above claims, characterized in that the crankshaft is brought by the electric machine (14) into the start position during the positioning phase and that compression and fill level of the first cylinder going into compression are reduced by a pregiven dwell duration in the start position via leakages of the cylinder.

14. Start method of claim 13, characterized in that the crankshaft (11) is held in its start position until the gas spring pressure of the cylinder going into compression has dropped to a residual value via leakages.

15. Start method of one of the above claims, characterized in that, for an internal combustion engine having direct injection, the pregiven fuel quantity is injected during the first compression phase with reduced compression.

16. Start method of one of the claims 1 to 14, characterized in that, for an engine having intake manifold injection, the pregiven fuel quantity is injected via the still-open inlet valve in advance of preferably the first compression phase with reduced compression, preferably, starting at bottom dead center of the cylinder going into compression.

17. Start method of one of the above claims, characterized in that with the first reduced compression, which is pregiven by the start position of the crankshaft (11), an air fill level of 25 to 40% is obtained.

18. Start method of one of the above claims, characterized in that, when reaching a pregiven rpm value of the crankshaft (11), the charge level and the compression are set to 100% of the idle values.

19. Start arrangement for an internal combustion engine of a vehicle for carrying out a start method of claim 1, characterized in that the start control apparatus (19) is connected at the input end to a rotation and position sensor (12) of the crankshaft (11) for carrying out the positioning and start phase and is connected at its output end to a valve control and a fuel injection control (18) of the engine (10).
